(19) United States
(12) Patent Application Publication
(10) Pub. No.: US 2014/0057103 A1
(43) Pub. Date: Feb. 27, 2014

(54) Line Systems and Methods and Chafe Jackets Therefor

(71) Applicants: Greg Z. Mozsgai, Ferndale, WA (US); Francis W. Choltco-Devlin, Ferndale, WA (US); Chia-Te Chou, Ferndale, WA (US)

(72) Inventors: Greg Z. Mozsgai, Ferndale, WA (US); Francis W. Choltco-Devlin, Ferndale, WA (US); Chia-Te Chou, Ferndale, WA (US)

(73) Assignee: SAMSON ROPE TECHNOLOGIES, Ferndale, WA (US)

(21) Appl. No.: 13/594,681

(22) Filed: Aug. 24, 2012

(51) Int. Cl. F16L 11/02; D04C 1/00; D02G 3/36

(52) U.S. Cl. 428/365; 156/149; 428/375; 428/398; 428/376; 87/9

(57) ABSTRACT

A chafe jacket is used with a line extending around a structure comprising a tube structure defining an inner surface and a jacket axis. The tube structure comprises fibers each defining a fiber axis. The fiber axes defined by portions of the fibers defining the interior surface of the tube structure extend at an interior fiber angle of less than approximately 50 degrees relative to the jacket axis. The chafe jacket extends around at least a portion of the line adjacent to the structure to reduce wear on the line.

### TECHNICAL FIELD

The present invention relates to line systems and methods and, in particular, rope systems and methods incorporating a chafe jacket.

### BACKGROUND

The term “line” will be used herein generally to refer to a flexible member such as a rope, cable, wire, or chain adapted to be placed in tension between two structural members. Both of the structural members may be fixed, but more commonly one of the structural members is fixed and the other structural member is movable. A line is also sometimes arranged to extend between two movable structural members. Lines are also often further arranged such that an intermediate portion thereof extends at least partly around or otherwise engages a structural member made of rigid material such as a pulley, bollard, winch, or the like.

Lines are typically formed of materials and structures that are at least partly flexible to allow the line to be bent, curved, wrapped, and the like. Flexible materials and structures tend to be susceptible to wear as the line is used. And because lines are typically connected to or extend around structural members made of rigid material, friction between the line and the structural member may also encourage wear of the line.

Lines are thus frequently replaced either periodically or when inspection suggests wear that might compromise the ability of the line to perform its intended function. Replacement of lines can introduce expense due to the replacement cost of the line and/or loss of use of the equipment with which the line is used.

The need thus exists for improved line systems and methods that minimize wear on lines.

### SUMMARY

The present invention may be embodied as a line system comprising a line and a chafe jacket. The chafe jacket comprises a tube structure defining an inner surface and a jacket axis. The tube structure comprises fibers each defining a fiber axis. The fiber axes defined by portions of the fibers defining the interior surface of the tube structure extend at an interior fiber angle of less than approximately 50 degrees relative to the jacket axis. The chafe jacket extends around at least a portion of the line to reduce wear on the line.

The prevent invention may be embodied as a chafe jacket for use with a line extending around a structure comprising a tube structure defining an inner surface and a jacket axis. The tube structure comprises fibers each defining a fiber axis. The fiber axes defined by portions of the fibers defining the interior surface of the tube structure extend at an interior fiber angle of less than approximately 50 degrees relative to the jacket axis. The chafe jacket extends around at least a portion of the line adjacent to the structure to reduce wear on the line.

The present invention may also be embodied as a method of protecting a line extending around a structure comprising the following steps. Fibers defining a fiber axis are provided. The fibers are combined to form a tube structure defining an inner surface, a cavity and a jacket axis. The fiber axes defined by portions of the fibers defining the interior surface of the tube structure extend at an interior fiber angle of less than approximately 50 degrees relative to the jacket axis. The line is arranged at least partly through the cavity such that the chafe jacket extends around at least a portion of the line adjacent to the structure to reduce wear on the line.

### BRIEF DESCRIPTION OF THE DRAWINGS

FIG. 1 is a side elevation, somewhat schematic view of a first example line system of the present invention;

FIG. 2 is a section view taken along lines 2-2 in FIG. 1;

FIG. 3 is a section view taken along lines 3-3 in FIG. 1;

FIG. 4 is a side elevation, somewhat schematic view of a tube structure forming part of the first example line system, with a portion of the tube structure removed and portions of the tube structure magnified for clarity;

FIG. 5 is a side elevation, somewhat schematic view of a second example line system of the present invention;

FIG. 6 is a side elevation, somewhat schematic view of a tube structure forming part of the second example line system;

FIG. 7 is a side elevation, somewhat schematic view of a third example line system of the present invention;

FIG. 8 is a section view taken along lines 8-8 in FIG. 7;

FIG. 9 is a side elevation, somewhat schematic view of a fourth example line system of the present invention;

FIG. 10 is a section view taken along lines 10-10 in FIG. 9;

FIG. 11 is a side elevation, somewhat schematic view of a fifth example line system of the present invention;

FIG. 12 is a section view taken along lines 12-12 in FIG. 11;

FIG. 13 is a side elevation, somewhat schematic view of a sixth example line system of the present invention;

FIG. 14 is a section view taken along lines 14-14 in FIG. 13;

FIG. 15 is a schematic view illustrating a first example use configuration illustrating use of the first example chafe jacket;

FIG. 16 is a schematic view illustrating a second example use configuration illustrating use of the first example chafe jacket;

FIG. 17A is a schematic view illustrating a seventh example line system; and

FIG. 17B is a schematic view illustrating a third example use configuration illustrating use of a seventh example chafe jacket.

### DETAILED DESCRIPTION

The present invention may be embodied in a number of forms, and several different examples of the present invention will be discussed below. In the following discussion, the term “axis” will be used to refer to a first direction in which a dimension of a particular structure (e.g., rope, jacket, tube structure, bundle, strand, fiber) is larger than in the dimensions of that particular structure in the two directions orthogonal to the first direction. An axis need not be straight, and the term “local” refers to the direction of an axis at any particular point along the axis of a structure. The term “radial” refers to any direction orthogonal to an axis of a structure. The terms “inward”, “inner”, and/or “interior” refer to a position or direction adjacent, facing, or extending towards an axis of a structure, while the terms “outward”, “outer”, and/or “exterior” refer to a position or direction distal from, facing away from, or extending away from an axis of a structure.

### 1. First Example Line System

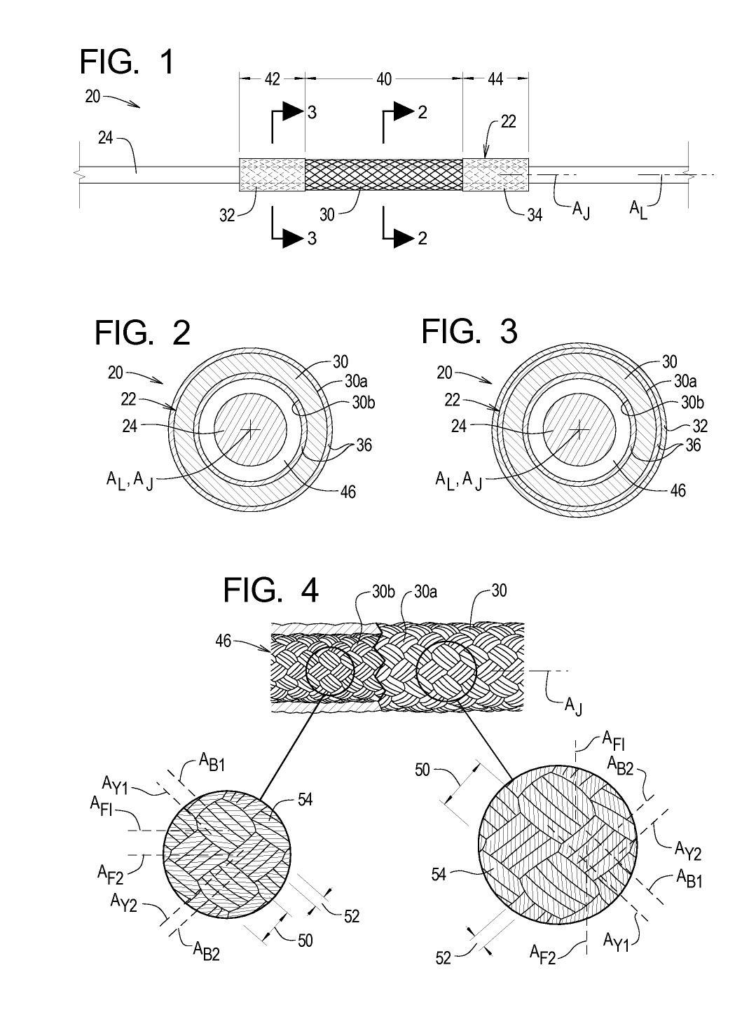

Referring initially to FIGS. 1-4 of the drawing, depicted therein is a first example line system 20 constructed in accordance with, and embodying, the principles of the present invention. The example line system 20 comprises a first example chafe jacket 22 and a line 24. The line 24 is or may be formed from a conventional synthetic rope and will not be described herein beyond that extent necessary for a complete understanding of the present invention.

The first example chafe jacket 22 comprises a tube structure 30, optional first and second bindings 32 and 34, and an optional coating 36. The example tube structure 30 defines a main portion 40, first and second end portions 42 and 44, and a cavity 46. The first and second bindings 32 and 34 are formed on the outer surface 30a of the tube structure 30 over the first and second end portions 42 and 44, respectively. The optional coating 36 is applied to the tube structure 30 such that entire outer surface 30a and inner surface 30b are coated. In the example chafe jacket 22, the portion of the coating 36 on the outer surface 30a of the tube structure 30 at the first and second end portions 42 and 44 is substantially between the first and second bindings 32 and 34 and the tube structure 30, respectively.

The first example tube structure 30 is a woven or braided structure comprising a plurality of bundles 50. Each of the bundles 50 comprises a plurality of yarns 52. Each of the plurality of yarns 52 comprises a plurality of fibers 54. As an alternative to a woven or braided structure, the tube structure 30 may be formed of yarns and/or fibers that are combined to form a bonded structure. In a bonded structure, a first set of inner yarns or fibers are laid up and a second set of outer yarns or fibers is bonded to the first set to hold the first set in a desired configuration. In the example tube structure 30, the second set of yarns or fibers hold the first set in a tubular configuration to define a generally cylindrical cavity like the cavity 46 described above.

As shown in FIGS. 1-3, the jacket 22 defines a jacket longitudinal axis A_{J}, and the line 24 defines a line longitudinal axis A_{L}. The jacket 22 and line 24 are flexible, so the longitudinal axes A_{J} and A_{L} are generally defined locally with reference to center of the jacket 22 and line 24 when in straight and substantially un-deformed configuration. In general, when the jacket 22 is arranged to cover a portion of the line 24, the longitudinal axes A_{J} and A_{L} are substantially parallel and may be aligned depending on the shape of the line system 20. As depicted in FIGS. 1-3, the jacket 22 and line 24 are straight, and the longitudinal axes A_{J} and A_{L} are substantially aligned. However, during normal use of the line system 20 these axes A_{J} and A_{L} are curved or bent, and the line 24 engages one inner wall of the jacket 22 such that the axes A_{J} and A_{L} are slightly offset from each other but locally substantially parallel.

FIG. 4 further illustrates that the bundles 50 define a bundle axis A_{B}, and two example bundle axes A_{B1} and A_{B2} are identified. The yarns 52 each define a yarn axis A_{Y}, and two example yarn axes A_{Y1} and A_{Y2} are identified. The fibers 54 each define a fiber axis A_{F}, and two example fiber axes A_{F1} and A_{F2} are identified.

The example bundle axes A_{B} substantially extend along a generally circular path relative to the jacket axis A_{J}. The yarn axis A_{Y} of each of the yarns 52 substantially extends along a generally circular path relative to the jacket axis A_{J} similar to the circular path defined by the bundle axes of the bundle 50 including that yarn 52. If the jacket axis A_{J} is straight, the example tube structure 30 is woven such that the bundle axes A_{B} and yarn axes A_{Y} form intertwined helical shapes in two different crossing directions. These helical shapes will further have minor radially in and out fluctuations (or crimps) as bundles/yarns extending in one crossing direction are passed under and over bundles/yarns in the other crossing direction.

In the first example chafe jacket 22, the fibers 54 are combined to form the yarns 52, the yarns 52 are combined to form the bundles 50, and the bundles 50 are woven to form the tube structure 30 such that the fiber axes A_{F} defined by the fibers 54 defining an interior surface 30b of the tube structure 30 extend at an angle of approximately zero with respect to the jacket axis A_{J}. In the dose up of the inside surface 30b of the example tube structure 30 depicted in FIG. 4, the representative fibers axes A_{F1} and A_{F2} are thus depicted as being substantially parallel to the jacket axis A_{J}. An interior fiber angle between the fiber axes A_{F} on the interior surface 30b and the jacket axis A_{J} is approximately 0° in the example tube structure 30 and should in any event be within a first range of approximately 0° to 20° or within a second range of approximately 0° to 50°. This fiber orientation reduces friction between the first example chafe jacket 22 and the line 24.

In a bonded tube structure, the yarns and fibers are oriented such that the fiber axes A_{F} of the fibers forming the first or inner layer of the bonded structure extend at an fiber angle of approximately 0° and should in any event be within a first range of approximately 0° to 20° or within a second range of approximately 0° to 50°.

On the other hand, in a typical woven or braided structure such as the first example tube structure 30 the fiber axes A_{F} defined by the fibers 54 exposed to the exterior surface 30a of the tube structure 30 extend at an angle of approximately 90° with respect to the jacket axis A_{J}. In the close up of the exterior surface 30a of the example tube structure 30 depicted in FIG. 4, the representative fiber axes A_{F1} and A_{F2} are thus depicted as being substantially perpendicular to the jacket axis A_{J}. An exterior fiber angle between the fiber axes on the exterior surface and the jacket axis should be within a first range of approximately 70° to 110° and in any event should be within a second range of approximately 40° to 140°. This fiber orientation increases friction between the first example chafe jacket 22 and any structure in contact with the exterior surface 30a. In a bonded tube structure, the fibers in the second or outer layer may be formed to such that the fiber axes A_{F} extend at an angle of approximately 90° with respect to the jacket axis A_{J} and should in any event be within a first range of approximately 70° to 110° or within a second range of approximately 40° to 140°.

In use, the line 24 is arranged at least partly within the cavity 46 such that the chafe jacket 22 extends around at least a portion of the line 24. The orientation of the fiber axes A_{F} limits friction and other causes of wear on the portion of the line around which the chafe jacket 22 extends are limited during normal use of the line system 20, extending the life of the line 24. The optional bindings 32 and 34 inhibit unraveling of the tube structure 30. The optional coating 36 further reduces friction where the line 24 is in contact with the chafe jacket 22.

The tube structure 30 of the first example jacket 22 is typically formed of synthetic fibers such as polyester and/or high modulus polyethylene (HMPE), but natural fibers may be used. The example tube structure 30 of the first example jacket 22 may be formed of one or more of the following materials: polyester, polyolefin, polyamide (PA), polyethylene terephthalate/polyethersulfone (PET/PES), polypropylene (PP), polyethylene (PE), high modulus polyethylene (HMPE), liquid crystal polymer (LCP), Para-Aramid, poly p-phenylene-2,6-benzobisoxazole (PBO) fibers, high modulus polypropylene (HMPP), and PP/PE blends, but other materials may be used depending on considerations such as characteristics of the line 24, the nature of the operating environment, cost, and the like.

The binding 32 is typically, but not necessarily formed of the same material as the binding 34. The example first and second bindings 32 and 34 are formed of a coating material that is applied in a liquid form and allowed to dry to form a resilient structure. A material commonly referred to as castable polyurethane may be used to form the example bindings 32 and 34. Other flexible and durable materials such as synthetic or natural rubbers may be used in addition or instead as the bindings 32 and 34. In any event, the material forming the bindings 32 and 34 should have the following properties when set or dry: good adhesion to fiber, stickiness, softness, flexibility to accommodate movements of the tube structure 30

Typically, but not necessarily, the resilient structure forming the bindings 32 and 34 is adhered to the fibers 54 and/or extends at least partly between the yarns 52 and/or fibers 54 forming the tube structure 30 to secure the bindings 32 and 34 in place on the end portions 42 and 44. In this case, the bindings 32 and 34 may be formed by spraying, brushing, dipping, or otherwise applying the coating material in liquid form to the exterior surface 30a of the tube structure 30 and allowing the coating material to dry to form the bindings 32 and 34.

Alternatively, the bindings 32 and 34 may be formed by resilient sleeves placed over the end portions 42 and 44 of the tube structure. In this case, the sleeves forming the bindings 32 and 34 may not be adhered to the tube structure 30, and the sleeves are held in place by friction. A contact or heat activated adhesive may be formed on the inner surfaces of the sleeves forming the bindings 32 and 34 to secure the bindings 32 and 34 to the fibers 54 defining the exterior surface 30a at the end portions 42 and 44 of the tube structure 30.

As other alternatives, the bindings 32 and 34 may be formed by tape or elongate band wrapped around the end portions 42 and 44 of the tube structure and secured in place by adhesive or other appropriate means, by sewn hem, and/or by laminated sheets of thermoplastic material.

The optional coating 36 may be formed by a coating material that is applied by spraying, brushing, dipping, or otherwise applying the coating material in liquid form such that at least an interior surface 30b of the tube structure 30 is coated when the chafe jacket 22 is formed. The coating material is applied in liquid form and allowed to dry to form the coating 36. The coating material used to form the example coating 36 may, in liquid form, be a mixture comprising a base forming the carrier portion and binder portion and, optionally, a lubricant portion. Alternative products that may be used as the base material include polyurethane dispersions; in any event, the base material should have the following properties: good adhesion to fiber, stickiness, softness, flexibility to accommodate movements of the tube structure 30. The base of the coating material is or may be conventional and will not be described herein in further detail.

If used, the lubricant portion of the coating material forming the coating 36 may be a solid material generically known as PolyTetraFluoroEthylene (PTFE) but commonly referred to by the tradename Teflon. The PTFE used as the lubricant portion is typically sourced in powder form, although other forms may be used if available. As an alternative to PTFE, the lubricant portion may be formed by solids of other materials and/or by a liquid such as silicone oil. Other example materials that may form the lubricant portion include graphite, silicon, molybdenum disulfide, tungsten disulfide, and other natural or synthetic oils. In any case, enough of the lubricant portion should be used to yield an effect generally similar to that of the PTFE as described above.

In the example jacket 22, the optional coating 36 is applied to the fibers 54 before the fibers 54 are combined to form the yarns 52. Accordingly, the depiction of the optional coating 36 is highly schematic in that the coating will extend throughout the tube structure 30 and does not reside only on the surfaces 30a and 30b as depicted. However, the coating 36 may be applied to the yarns 52, the bundles 50, and/or to the tube structure 30 itself after these components have been formed. A coating 36 formed after the tube structure 30 has been formed will reside primarily on the surfaces 30a and/or 30b but may extend at least partly within the spaces between the fibers 54. The example coating 36 will typically, but not necessarily, be formed before the optional bindings 32 and 34 are formed. When the coating 36 is formed before the bindings 32 and 34, the material forming the bindings 32 and 34 should be compatible with the material forming coating 36 such that the bindings 32 and 34 stay in place relative to the tube structure 30 during normal use.

The line 24 is not is per se part of the present invention but will also typically be formed of synthetic fibers; again, natural fibers may be used to form the line 24. The example line 24 used in conjunction with the first example jacket 22 may be formed of one or more of the following materials: polyester, polyolefin, polyamide (PA), polyethylene terephthalate/polyethersulfone (PET/PES), polypropylene (PP), polyethylene (PE), high modulus polyethylene (HMPE), liquid crystal polymer (LCP), Para-Aramid, poly p-phenylene-2,6-benzobisoxazole (PBO) fibers, high modulus polypropylene (HMPP), and PP/PE blends, but other materials may be used depending on considerations such as characteristics of the line 24, the nature of the operating environment, cost, and the like.

### 2. Second Example Line System

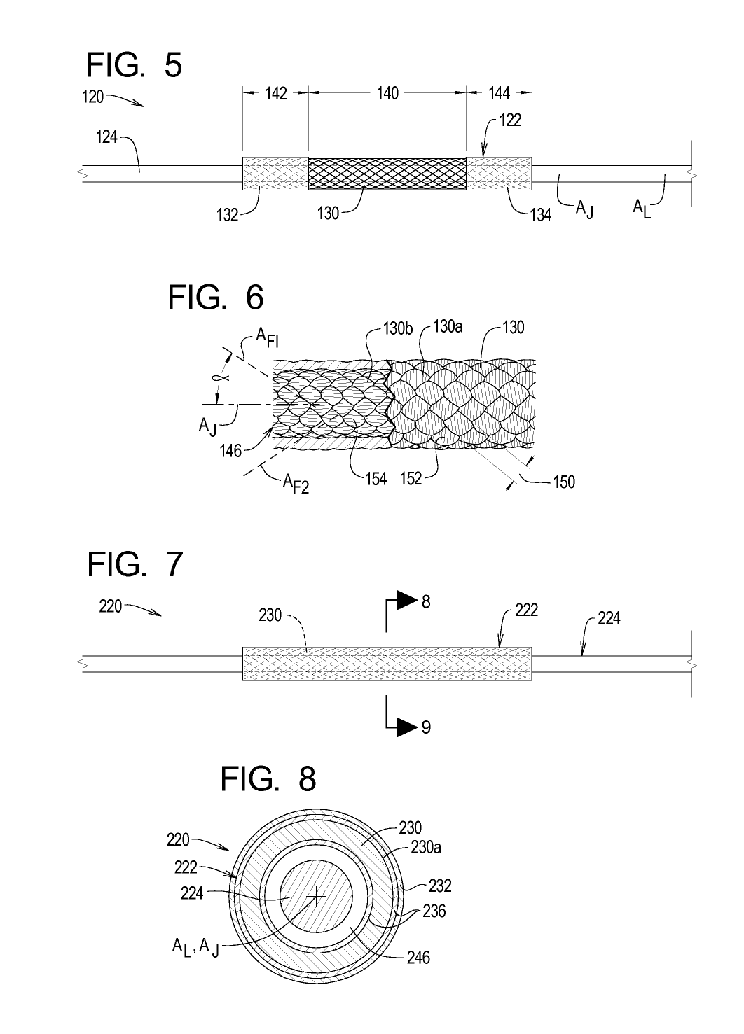

Referring now to FIGS. 5 and 6 of the drawing, depicted therein is a second example line system 120 constructed in accordance with, and embodying, the principles of the present invention. The example line system 120 comprises a second example chafe jacket 122 and a line 124. The line 124 is or may be formed from a conventional synthetic rope and will not be described herein beyond that extent necessary for a complete understanding of the present invention.

The second example chafe jacket 122 comprises a tube structure 130, optional first and second bindings 132 and 134, and an optional coating 136. The example tube structure 130 defines a main portion 140, first and second end portions 142 and 144, and a cavity 146. The first and second bindings 132 and 134 are formed on an exterior surface 130a of the tube structure 130 over the first and second end portions 142 and 144, respectively.

The second example tube structure 130 is a woven or braided structure comprising a plurality of yarns 152. Each of the plurality of yarns 152 comprises a plurality of fibers 154. The yarns 152 or 154 may be combined to form rope components such as strands, but, unlike the example tube structure 30 described above, the weave or braid does not comprise a bundle comprising parallel rope components. Again, a bonded structure may be used to form the tube structure 130.

As shown in FIG. 5, the jacket 122 defines a jacket longitudinal axis A_{J}, and the line 124 defines a line longitudinal axis A_{L}. The jacket 122 and line 124 are flexible, so the longitudinal axes A_{J} and A_{L} are generally defined locally with reference to a nominal diameter of the jacket 122 and line 124. In general, when the jacket 122 is arranged to cover a portion of the line 124, the longitudinal axes A_{J} and A_{L} are substantially parallel and may be aligned depending on the shape of the line system 120. As depicted in FIGS. 5 and 6, the jacket 122 and line 124 are straight, and the longitudinal axes A_{J} and A_{L} are substantially aligned. However, during normal use of the line system 120 these axes A_{J} and A_{L} are typically slightly offset from each other but locally parallel.

FIG. 6 further illustrates that the yarns 152 each define a yarn axis A_{Y}, and two example yarn axes A_{Y1} and A_{Y2} are identified. The fibers 154 each define a fiber axis A_{F}, and two example fiber axes A_{F1} and A_{F2} are identified.

The yarn axis A_{Y} of each of the yarns 152 substantially extends along a generally circular path relative to the jacket axis A_{J}. If the jacket axis A_{J} is straight, the example tube structure 130 is woven such that the yarn axes form intertwined helical shapes in two different crossing directions. In a braided or woven structure, these helical shapes will further have minor radially in and out fluctuations or crimps as yarns extending in one crossing direction are passed under and over yarns in the other crossing direction.

In the second example chafe jacket 122, the fibers 154 are combined to form the yarns 152, the yarns 152 are braided to form the tube structure 130 such that the fiber axes defined by the fibers 154 defining an interior surface 130b of the tube structure 130 extend at an angle of approximately 0° with respect to the jacket axis A_{J}. The representative fibers axes A_{F1} and A_{F2} shown in FIG. 6 are thus depicted as being substantially parallel to the jacket axis A_{J}. An interior fiber angle between the fiber axes on the interior surface 130b and the jacket axis A_{J} may be within a first range of approximately 0° to 20° and in any event should be within a second range of approximately 0° to 40°. This fiber orientation reduces friction between the second example chafe jacket 122 and the line 124.

On the other hand, the fiber axes defined by the fibers 154 exposed to the exterior surface 130a of the tube structure 130 extend at an angle of approximately 90° with respect to the jacket axis A_{J}. As depicted in FIG. 6, in the exterior surface 130a of the example tube structure 130 the representative fibers axes A_{F1} and A_{F2} are substantially perpendicular to the jacket axis A_{J}. An exterior fiber angle between the fiber axes on the exterior surface and the jacket axis should be within a first range of approximately 70° to 110° and in any event should be within a second range of approximately 40° to 140°. This fiber orientation increases friction between the second example chafe jacket 122 and the any structure in contact with the exterior surface 130a.

In use, the line 124 is arranged at least partly within the cavity 146 such that the chafe jacket 122 extends around at least a portion of the line 124. Abrasion and other causes of wear on the portion of the line around which the chafe jacket 122 extends are limited during normal use of the line system 120, extending the life of the line 124.

The tube structure 130, first and second bindings 132 and 134, coating 136, and line 124 may be made of the same materials and in the same manner as the tube structure 30, first and second bindings 32 and 34, coating 36, and line 24, respectively, as disclosed above.

### 3. Third Example Line System

Referring now to FIGS. 7 and 8 of the drawing, depicted therein is a third example line system 220 constructed in accordance with, and embodying, the principles of the present invention. The example line system 220 comprises a third example chafe jacket 222 and a line 224. The line 224 is or may be formed from a conventional synthetic rope and will not be described herein beyond that extent necessary for a complete understanding of the present invention.

The third example chafe jacket 222 comprises a tube structure 230, an optional binding 232, and an optional coating 234. The example binding 232 is formed over an entire exterior surface 230a of the tube structure 230. The example coating 234 extends over at least an entire inner surface 230b of the tube structure 230 and, in the example chafe jacket 222, extends over both the outer surface 230a and the inner surface 230b.

In use, the line 224 is arranged at least partly within a cavity 240 defined by the chafe jacket 222 such that the chafe jacket 222 extends around at least a portion of the line 224. Abrasion and other causes of wear on the portion of the line around which the chafe jacket 222 extends are limited during normal use of the line system 220, extending the life of the line 224.

The tube structure 230, binding 232, coating 234, and line 224 may be made of the same materials and in the same manner as the tube structures 30 and 130, first and second bindings 32 and 34, coating 36, and line 24, respectively, as disclosed above.

### 4. Fourth Example Line System

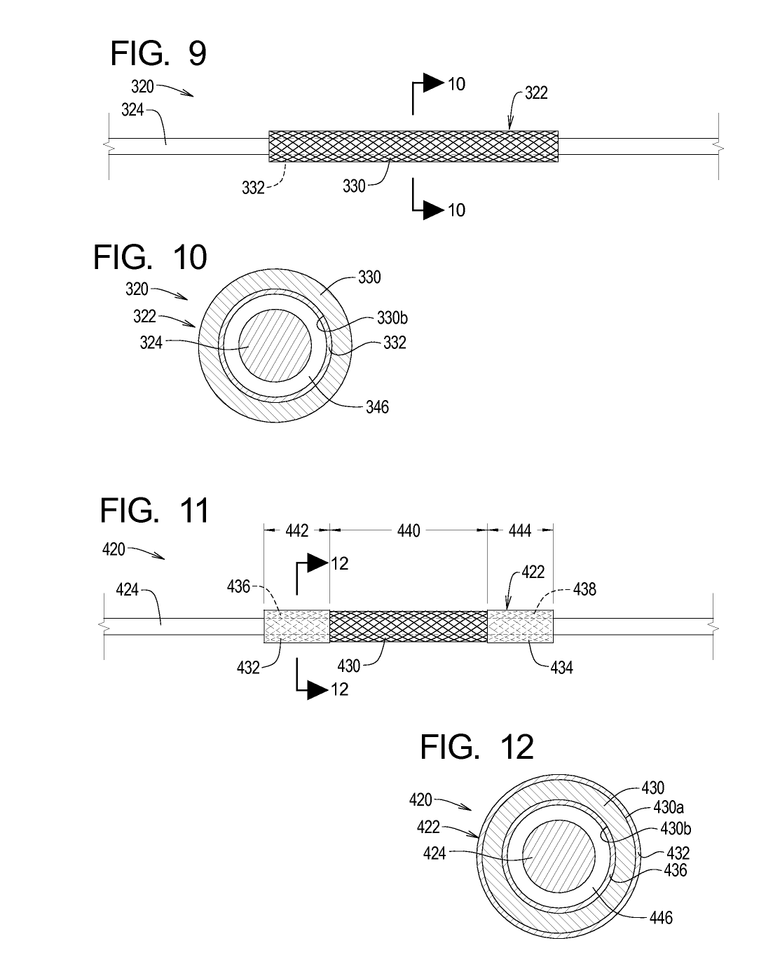

Referring now to FIGS. 9 and 10 of the drawing, depicted therein is a fourth example line system 320 constructed in accordance with, and embodying, the principles of the present invention. The example line system 320 comprises a fourth example chafe jacket 322 and a line 324. The line 324 is or may be formed from a conventional synthetic rope and will not be described herein beyond that extent necessary for a complete understanding of the present invention.

The fourth example chafe jacket 322 comprises a tube structure 330 and an optional coating 332. The example coating 332 is formed over an interior exterior surface 330b of the tube structure 330.

In use, the line 324 is arranged at least partly within a cavity 340 defined by the chafe jacket 322 such that the chafe jacket 322 extends around at least a portion of the line 324. Abrasion and other causes of wear on the portion of the line around which the chafe jacket 322 extends are limited during normal use of the line system 320, extending the life of the line 324.

The tube structure 330, coating 332, and line 324 may be made of the same materials and in the same manner as the tube structures 30, 130, and 230, coating 36, and line 24, respectively, as disclosed above.

### 5. Fifth Example Line System

Referring now to FIGS. 11 and 12 of the drawing, depicted therein is a fifth example line system 420 constructed in accordance with, and embodying, the principles of the present invention. The example line system 420 comprises a fifth example chafe jacket 422 and a line 424. The line 424 is or may be formed from a conventional synthetic rope and will not be described herein beyond that extent necessary for a complete understanding of the present invention.

The fifth example chafe jacket 422 comprises a tube structure 430 and optional first and second bindings 432 and 434, and an optional coating 436. The example tube structure 430 defines a main portion 440, first and second end portions 442 and 444, and a cavity 446. The first and second bindings 432 and 434 are formed on an exterior surface 430a of the tube structure 430 over the first and second end portions 442 and 444 thereof. The coating 436 is formed on the entire interior surface 430b of the tube structure 430.

In use, the line 424 is arranged at least partly within the cavity 446 defined by the chafe jacket 422 such that the chafe jacket 422 extends around at least a portion of the line 424. Abrasion and other causes of wear on the portion of the line around which the chafe jacket 422 extends are limited during normal use of the line system 420, extending the life of the line 424.

The tube structure 430, bindings 432 and 434, coating 436, and the line 424 may be made of the same materials and in the same manner as the tube structures 30 and 130, first and second bindings 32 and 34, coating 36, and line 24, respectively, as disclosed above.

### 6. Sixth Example Line System

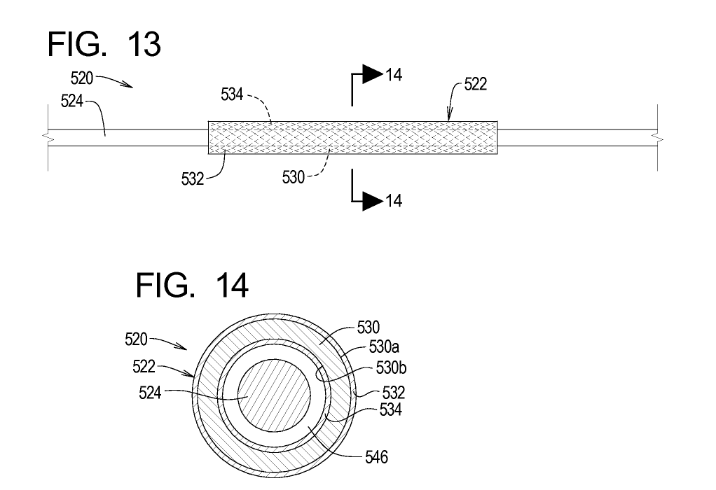

Referring now to FIGS. 13 and 14 of the drawing, depicted therein is a sixth example line system 520 constructed in accordance with, and embodying, the principles of the present invention. The example line system 520 comprises a sixth example chafe jacket 522 and a line 524. The line 524 is or may be formed from a conventional synthetic rope and will not be described herein beyond that extent necessary for a complete understanding of the present invention.

The sixth example chafe jacket 522 comprises a tube structure 530, an optional binding 532, and an optional coating 530. The binding 530 is formed on an entire exterior surface 530a of the tube structure 430. The coating is formed on an entire interior surface 530b of the tube structure 530.

In use, the line 524 is arranged at least partly within a cavity 540 defined by the chafe jacket 522 such that the chafe jacket 522 extends around at least a portion of the line 524. Abrasion and other causes of wear on the portion of the line around which the chafe jacket 522 extends are limited during normal use of the line system 520, extending the life of the line 524.

The tube structure 530, bindings 532 and 534, and the line 524 may be made of the same materials and in the same manner as the tube structures 30 and 130, first and second bindings 32 and 34, coating 36, and line 24, respectively, as disclosed above.

### 7. First Example Use Configuration

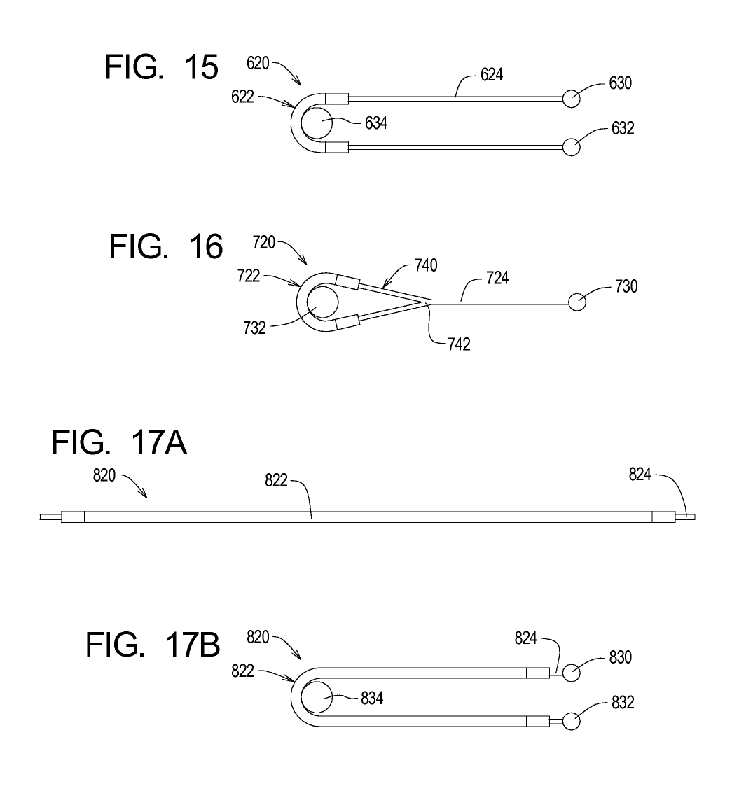

A first example use configuration of any of the example line systems disclosed herein is depicted in FIG. 15. The first example use configuration comprises a line assembly 620 comprising a chafe jacket 622 and a line 624. The ends of the line 624 are operatively connected to first and second terminal structures 630 and 632. A portion of the line 624 extends at least partly around an intermediate structure 634. The chafe jacket 622 is arranged to surround the portion of the line 624 that extends around the intermediate structure 634.

### 8. Second Example Use Configuration

A second example use configuration of any of the example line systems disclosed herein is depicted in FIG. 16. The second example use configuration comprises a line assembly 720 comprising a chafe jacket 722 and a line 724. One end of the line 724 is operatively connected to a first terminal structure 730. A portion of the line assembly 720 extends around a second terminal structure 732. In particular, the example line 724 defines an eye portion 740 formed by splicing an end of the line 724 at a splice portion 742 of the line 724. The chafe jacket 722 is arranged to surround the eye portion of the line assembly 724 that extends around the second terminal structure 732. In this case, the splice formed at the splice portion 742 will be formed after the jacket 722 is arranged on the eye portion 740.

### 9. Third Example Use Configuration

A third example use configuration of a seventh example line system 820 depicted in FIG. 17A is depicted in FIG. 17B. The seventh example line system 820 of the third example use configuration comprises a chafe jacket 822 and a line 824. The ends of the line 824 are operatively connected to first and second terminal structures 830 and 832. A portion of the line 824 extends at least partly around an intermediate structure 834. The chafe jacket 822 is arranged to surround the portion of the line 824 that extends around the intermediate structure 834. In the seventh example line system 820, the seventh example chafe jacket 822 is nearly as long as the line 824 and extends substantially between the first and second terminal structures 830 and 832. Any of the example chafe jackets described above may be extended to form the seventh example chafe jacket 822.

What is claimed is:

1. A line system, comprising:
a line; and
a chafe jacket comprising a tube structure defining an inner surface and a jacket axis, where
the tube structure comprises fibers each defining a fiber axis, and
the fiber axes defined by portions of the fibers defining the interior surface of the tube structure extend at an interior fiber angle of less than approximately 50 degrees relative to the jacket axis; wherein
the chafe jacket extends around at least a portion of the line to reduce wear on the line.

2. A line system as recited in claim 1, in which the interior fiber angle is less than approximately 20 degrees.

3. A line system as recited in claim 1, in which the fiber axes of portions of the fibers defining the interior surface of the tube structure are substantially parallel with the jacket axis.

4. A line system as recited in claim 1, further comprising at least one binding formed on the tube structure.

5. A line system as recited in claim 4, in which the at least one binding is formed on an exterior surface of the tube structure.

6. A line system as recited in claim 4, in which first and second bindings are formed at spaced locations on the tube member.

7. A line system as recited in claim 1, further comprising a coating formed on the tube structure.

8. A line system as recited in claim 7, in which the coating is formed on the interior surface of the tube structure.

9. A line system as recited in claim 4, further comprising a coating formed on the tube structure.

10. A line system as recited in claim 5, in which a coating is formed on the interior surface of the tube structure.

11. A line system as recited in claim 1, in which the tube structure is woven.

12. A line system as recited in claim 1, in which the tube structure is braided.

13. A line system as recited in claim 1, in which the tube structure is bonded.

14. A line system as recited in claim 1, in which the tube structure further defines an outer surface, and the fiber axes defined by portions of the fibers defining the outer surface of the tube structure extend at an exterior fiber angle of between approximately 50 degrees and 140 degrees relative to the jacket axis

15. A chafe jacket for use with a line extending around a structure, comprising:
a tube structure defining an inner surface and a jacket axis, where
the tube structure comprises fibers each defining a fiber axis, and
the fiber axes defined by portions of the fibers defining the interior surface of the tube structure extend at an interior fiber angle of less than approximately 50 degrees relative to the jacket axis; wherein
the chafe jacket extends around at least a portion of the line adjacent to the structure to reduce wear on the line.

16. A chafe jacket as recited in claim 15, in which the interior fiber angle is less than approximately 20 degrees.

17. A chafe jacket as recited in claim 15, in which the fiber axes of portions of the fibers defining the interior surface of the tube structure are substantially parallel with the jacket axis.

18. A chafe jacket as recited in claim 15, further comprising at least one binding formed on the tube structure.

19. A chafe jacket as recited in claim 18, in which the at least one binding is formed on an exterior surface of the tube structure.

20. A chafe jacket as recited in claim 18, in which first and second bindings are formed at spaced locations on the tube member.

21. A chafe jacket as recited in claim 15, further comprising a coating formed on the tube structure.

22. A chafe jacket as recited in claim 21, in which the coating is formed on the interior surface of the tube structure.

23. A chafe jacket as recited in claim 18, further comprising a coating formed on the tube structure.

24. A chafe jacket as recited in claim 19, in which a coating is formed on the interior surface of the tube structure.

25. A chafe jacket as recited in claim 15, in which the tube structure is woven.

26. A chafe jacket as recited in claim 15, in which the tube structure is braided.

27. A chafe jacket as recited in claim 15, in which the tube structure is bonded.

28. A line system as recited in claim 15, in which the tube structure further defines an outer surface, and the fiber axes defined by portions of the fibers defining the outer surface of the tube structure extend at an exterior fiber angle of between approximately 50 degrees and 140 degrees relative to the jacket axis

29. A method of protecting a line extending around a structure, comprising the steps of:
providing fibers each defining a fiber axis;
combining the fibers to form a tube structure defining an inner surface, a cavity, and a jacket axis, where the fiber axes defined by portions of the fibers defining the interior surface of the tube structure extend at an interior fiber angle of less than approximately 50 degrees relative to the jacket axis; wherein
arranging the line at least partly through the cavity such that the chafe jacket extends around at least a portion of the line adjacent to the structure to reduce wear on the line.

30. A method as recited in claim 29, in which the fiber angle is less than approximately 20 degrees.

31. A method as recited in claim 29, in which the fiber axes of the portions of the fibers defining the interior surface are substantially parallel with the jacket axis.

32. A method as recited in claim 29, further comprising the step of forming at least one binding on the tube structure.

33. A method as recited in claim 32, in which the at least one binding is formed on an exterior surface of the tube structure.

34. A method as recited in claim 31, in which first and second bindings are formed at spaced locations on the tube member.

35. A method as recited in claim 28, further comprising the step of forming a coating on the tube structure.

36. A method as recited in claim 35, in which the coating is formed on the interior surface of the tube structure.

37. A method as recited in claim 32, further comprising a coating formed on the tube structure.

38. A method as recited in claim 33, in which a coating is formed on the interior surface of the tube structure.

39. A method as recited in claim 29, in which the tube structure is woven.

40. A method as recited in claim 29, in which the tube structure is braided.

41. A method as recited in claim 29, in which the tube structure is bonded.

42. A method as recited in claim 29, in which the tube structure is formed to define an outer surface, and the fiber axes defined by portions of the fibers defining the outer surface of the tube structure extend at an exterior fiber angle of between approximately 50 degrees and 140 degrees relative to the jacket axis.
